(19) United States
(12) Patent Application Publication
(10) Pub. No.: US 2008/0105848 A1
(43) Pub. Date: May 8, 2008

(54) Non-Flammable Composition And Use Thereof

(76) Inventor: Laurent Caron, Sainte Foy Les Lyon (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/593,945

(22) PCT Filed: Mar. 16, 2005
(86) PCT No.: PCT/FR05/00629

§ 371 Date: Oct. 6, 2006

(51) Int. Cl. C09K 3/00

(52) U.S. Cl. 252/67

(57) ABSTRACT

The present invention relates to compositions which can be used as expanding agent in the manufacture of thermosetting polymers. A more particular subject-matter of the invention is compositions comprising 1,1,1,3,3-pentafluorobutane (365 mfc), 1,1,1,3,3-pentafluoropropane (245 fa) and a hydrochlorocarbon compound.

The present invention relates to compositions which can be used as an expanding agent in the manufacture of thermosetting polymers. The more particular subject-matter of the invention is compositions comprising 1,1,1,3,3-pentafluorobutane (365 mfc), trans-1,2-dichloroethylene and at least one nonflammable hydrofluorocarbon and their use.

It is known to use 1,1,1,3,3-pentafluorobutane as expanding agent in the manufacture of foams, for example polyurethane or polyisocyanurate foams.

The document U.S. Pat. No. 6,451,867 teaches, for improving the insulating properties of rigid polyurethane or polyisocyanurate foams, the use of a binary mixture comprising 1,1,1,3,3-pentafluorobutane and 1,1,1,3,3-pentafluoropropane (245 fa) as expanding agent.

Furthermore, the document WO 02/099006 discloses a ternary mixture comprising 1,1,1,3,3-pentafluorobutane, 1,1,1,3,3-pentafluoropropane (245 fa) and approximately 23% by weight of trans-1,2-dichloroethylene. This mixture, according to the teaching of document WO 02/099006, has the advantage of exhibiting, for a constant ratio of 365 /245 fa, a relatively constant boiling point, that is to say one which varies very little with the amount of trans-1,2-dichloroethylene participating in the composition of the mixture.

The methods for the manufacture of polyurethane or polyisocyanurate foams are generally known and consist in general in reacting an organic polyisocyanate (including the diisocyanate) with a polyol or a mixture of polyols in the presence of an expanding agent.

The reaction between a polyisocyanate and a polyol or a mixture of polyols can be activated using an amine and/or other catalysts and surface-active agents.

In many applications, the components of the polyurethane or polyisocyanurate foams are premixes. More generally, the formulation of the foams is premixed as two components. The first component, better known under the name “component A”, comprises the isocyanate or polyisocyanate composition. The second component, better known under the name “component B”, comprises the polyol or the mixture of polyols, the surface-active agent, the catalyst(s) and the expanding agent(s).

The component B presents problems of flammability, even when the expanding agent participating in the composition of the premix is nonflammable.

In addition, problems of rise in pressure in the containers including the component B are often encountered during the storage thereof.

The present invention thus provides compositions which make it possible to solve all or part of the abovementioned problems.

A first subject-matter of the present invention relates to compositions comprising from 5 to 74% by weight of 1,1,1,3,3-pentafluorobutane (365 mfc), from 24 to 93% by weight of trans-1,2-dichloroethylene and from 2 to 46% by weight of 1,1,1,3,3-pentafluoropropane (245 fa).

The compositions according to the present invention preferably comprise from 8 to 61% by weight of 365 mfc, from 24 to 46% by weight of trans-1,2-dichloroethylene and from 15 to 46% by weight of 1,1,1,3,3-pentafluoropropane (245 fa).

The compositions according to the present invention advantageously comprise from 14 to 60% by weight of 365 mfc, from 25 to 40% by weight of trans-1,2-dichloroethylene and from 15 to 46% by weight of 1,1,1,3,3-pentafluoropropane (2.45 fa)

The compositions according to the first subject-matter of the invention can additionally comprise 1,1,1,3,3,3-hexafluoropropane (227 ea).

The compositions comprising from 5 to 25% by weight of 365 mfc, 65 to 90% by weight of trans-1,2 dichloroethylene and from 5 to 20% by weight of 245 fa are quite interesting.

The compositions according to the present invention do not exhibit a flash point under standard determination conditions (ASTM Standard D 3828). They can be used as expanding agent in the manufacture of thermosetting polymer foams, such as, for example, phenol/formaldehyde condensates or polyurethane. They are very particularly suitable for the manufacture of polyurethane or polyisocyanurate foams.

A second subject-matter of the present invention is an expanding agent, characterized in that it is composed of a composition according to the first subject-matter.

A third subject-matter of the present invention is a composition comprising a polyol or a mixture of polyols and an expanding agent according to the second subject-matter.

Mention may in particular be made, as polyols, of glycerol, ethylene glycol, trimethylolpropane, pentaerythritol, polyetherpolyols, for example those obtained by condensation of an alkylene oxide or of a mixture of alkylene oxides with glycerol, ethylene glycol, trimethylolpropane or pentaerythritol, or polyesterpolyols, for example those obtained from polycarboxylic acids, in particular oxalic acid, malonic acid, succinic acid, adipic acid, maleic acid, fumaric acid, isophthalic acid or terephthalic acid, with glycerol, ethylene glycol, trimethylolpropane or pentaerythritol.

The polyetherpolyols obtained by addition of alkylene oxides, in particular ethylene oxide and/or propylene oxide, to aromatic amines, in particular the mixture of 2,4- and 2,6-toluenediamine, are also suitable.

The composition according to the third subject-matter of the present invention preferably comprises from 1 to 60 parts by weight of expanding agent according to the second subject-matter per 100 parts by weight of polyol or mixture of polyols. Advantageously, it comprises from 5 to 35 parts by weight of expanding agent per 100 parts by weight of polyol or mixture of polyols.

A very particularly preferred composition of the present invention comprises 5 to 35 parts by weight of expanding agent composed of 8 to 61% by weight of 365 mfc, of 24 to 46% by weight of trans-1,2-dichloroethylene and of 15 to 46% by weight of 1,1,1,3,3-pentafluoropropane (245 fa) per 100 parts by weight of polyol or mixture of polyols. The particularly preferred composition can comprise 1,1,1,3,3,3-hexafluoropropane (227 ea).

An advantageously preferred composition of the present invention comprises 5 to 35 parts by weight of expanding agent composed of 14 to 60% by weight of 365 mfc, of 25 to 46% by weight of trans-1,2-dichloroethylene and of 15 to 46% by weight of 1,1,1,3,3-pentafluoropropane (245 fa) per 100 parts by weight of polyol or mixture of polyols. The advantageously preferred composition can comprise 1,1,1,3,3,3-hexafluoropropane (227 ea).

A composition comprising 5 to 35% by weight of expanding agent composed of 5 to 25% by weight of 365 mfc, 65 to 90% by weight of trans-1,2 dichloroethylene and from 5 to 20% by weight of 245 fa is also interesting. This composition can comprise 227 ea.

The composition according to the third subject-matter of the present invention can additionally comprise other expanding agent(s), a surface-active agent and one or more catalyst(s).

Preferably, the composition according to the third subject-matter of the present invention has the advantage of not exhibiting a flash point within the operating temperature range (−30 to 61° C.).

A fourth subject-matter of the present invention is a process for the manufacture of polyurethane or polyisocyanurate foams, according to which an organic polyisocyanate (including the diisocyanate) is reacted with a polyol or a mixture of polyols in the presence of an expanding agent according to the second subject-matter.

Advantageously, the process consists in reacting a composition according to the third subject-matter of the invention with an organic polyisocyanate, optionally in the form of a premix.

Mention may in particular be made, as polyisocyanate, of aliphatic polyisocyanates with a hydrocarbonaceous group which can range up to 18 carbon atoms, cycloaliphatic polyisocyanates with a hydrocarbonaceous group which can range up to 15 carbon atoms, aromatic polyisocyanates with an aromatic hydrocarbonaceous group having from 6 to 15 carbon atoms and arylaliphatic polyisocyanates with an arylaliphatic hydrocarbonaceous group having from 8 to 15 carbon atoms.

The preferred polyisocyanates are 2,4- and 2,6-diisocyanatotoluene, diphenylmethane diisocyanate, polymethylenepolyphenyl isocyanate and their mixture. Modified polyisocyanates, such as those comprising carbodiimide groups, urethane groups, isocyanurate groups, urea groups or biurea groups, may also be suitable.

The compositions according to the first subject-matter of the present invention can also be used as solvents, aerosols and/or cooling agents.

### EXAMPLES

Four expanding agent compositions (Tests 1-4) according to the present invention are prepared. Five parts by weight of each composition are then mixed with 100 parts by weight of polyol Stepanpol PS2412 (a polyol of polyester type). The flash point of each mixture is subsequently determined within the temperature range −30 to 61° C. under standard conditions (ASTM Standard D 3828).

By way of comparison, a composition (Test 5) not in accordance with the invention is prepared.

The results for each test are listed in the table below.

| | Composition of the | | | | |
|---|---|---|---|---|---|
| | expanding agent in weight % | | | Ratio | Flash |
| Test | 365mfc | Trans | 245fa | 365mfc/245fa | point (° C.) |
| 1 | 33 | 34 | 33 | 1 | >61 |
| 2 | 30 | 25 | 45 | 2/3 | >61 |
| 3 | 30 | 45 | 25 | 1.2 | >61 |
| 4 | 50 | 25 | 25 | 2 | >61 |
| 5 | 70 | 20 | 10 | 7 | 55 |

1. Composition comprising from 5 to 74% by weight of 1,1,1,3,3-pentafluorobutane (365 mfc), from 24 to 93% by weight of trans-1,2-dichloroethylene and from 2 to 46% by weight of 1,1,1,3,3-pentafluoropropane (245 fa).

2. Composition according to claim 1, characterized in that it comprises from 8 to 61% by weight of 365 mfc, from 24 to 46% by weight of trans-1,2-dichloroethylene and from 15 to 46% by weight of 1,1,1,3,3-pentafluoropropane (245 fa).

3. Composition according to claim 1, characterized in that it comprises from 14 to 60% by weight of 365 mfc, from 25 to 46% by weight of trans-1,2-dichloroethylene and from 15 to 46% by weight of 1,1,1,3,3-pentafluoropropane (245 fa).

4. Composition according to claim 1 characterized in that it comprises from 5 to 25% by weight of 365 mfc, 65 to 90% by weight of trans-1,2 dichloroethylene and from 5 to 20% by weight of 245 fa.

5. Composition according to claim 1, characterized in that it comprises 1,1,1,3,3,3-hexafluoropropane (227 ea).

6. Expanding agent, characterized in that it is composed of a composition according to claim 1.

7. Composition according to claim 1, characterized in that it comprises a polyol or a mixture of polyols.

8. Process for the manufacture of thermosetting polymer foams, characterized in that use is made of an expanding agent according to claim 6.

9. Composition according to claim 1, characterized in that it is used as solvents, aerosols and/or cooling agents.
